(19) United States
(12) Patent Application Publication
(10) Pub. No.: US 2026/0184513 A1
(43) Pub. Date: Jul. 2, 2026

(54) GOODS PICKING METHOD AND APPARATUS, AND ELECTRONIC DEVICE AND READABLE STORAGE MEDIUM

(71) Applicant: BEIJING GEEKPLUS TECHNOLOGY CO., LTD., Beijing (CN)

(72) Inventors: Xiguang WEI, Beijing (CN); Wenzhe TAN, Beijing (CN); Chengye ZHAO, Beijing (CN); Hongbo LI, Beijing (CN)

(21) Appl. No.: 19/130,086

(22) PCT Filed: Nov. 16, 2023
(86) PCT No.: PCT/CN2023/132034

§ 371 Date: May 14, 2025

(30) Foreign Application Priority Data
Nov. 18, 2022 (CN) 202211445093.X
Nov. 18, 2022 (CN) 202211450900.7

(51) Int. Cl. B65G 1/137; G06Q 10/087

(52) U.S. Cl. CPC B65G 1/1378; G06Q 10/08741

(57) ABSTRACT

A method for picking goods includes: obtaining orders to be handled; obtaining, in a case where the orders comprise at least one piece of first order information, a robot parameter of each robot in a warehouse system and an inventory receptacle parameter of a candidate inventory receptacle matching each piece of first order information, where the first order information indicates to-be-picked goods for which an inventory receptacle is not specified; determining a target inventory receptacle and a target robot according to the robot parameter of each robot and/or the inventory receptacle parameter of each candidate inventory receptacle; and generating a goods picking task according to the first order information and the target inventory receptacle, and sending the goods picking task to the target robot to make the target robot transport the target inventory receptacle to a target workstation corresponding to the first order information.

### CROSS-REFERENCE TO RELATED APPLICATIONS

The present application is a national stage entry under 35 U.S.C. §371 of International Application No. PCT/CN2023/132034, filed Nov. 16, 2023, which claims priority to Chinese Application No. 202211445093.X, filed Nov. 18, 2022, and Chinese Application No. 202211450900.7, filed Nov. 18, 2022. The entire disclosures of the above-identified applications are hereby incorporated herein by reference.

### TECHNICAL FIELD

The present disclosure relates to the field of intelligent warehouse, and in particular to a method and apparatus for picking goods, an electronic device and a readable storage medium.

### BACKGROUND

Goods picking is an important link in warehouse logistics. The goods picking efficiency directly determines a response speed of orders and affects the core competitiveness of an enterprise. In recent years, the vigorous development of robot technology has brought tremendous technological changes to the warehousing and logistics industry. With the development of intelligent warehouse systems, the way of picking goods has evolved from “person-to-goods” to “goods-to-person”.

### SUMMARY

According to a first aspect of embodiments of the present disclosure, a method for picking goods is provided. The method includes: first, obtaining orders to be handled; and the orders to be handled include a plurality pieces of order information. Secondly, in a case where the orders to be handled include at least one piece of first order information, a robot parameter corresponding to each of a plurality of robots in a warehouse system and an inventory receptacle parameter corresponding to a candidate inventory receptacle matching each piece of first order information are obtained; and the first order information indicates to-be-picked goods for which an inventory receptacle is not specified. Then, a target inventory receptacle is determined from at least one candidate inventory receptacle, and a target robot is determined from the plurality of robots, according to the robot parameter of each robot and/or the inventory receptacle parameter of each candidate inventory receptacle. Finally, a goods picking task is generated according to the first order information and the target inventory receptacle, and the goods picking task is sent to the target robot to make the target robot transport the target inventory receptacle to a target workstation corresponding to the first order information according to the goods picking task.

According to a second aspect of embodiments of the present disclosure, an electronic device is provided, including: a processor and a memory for storing computer executable instructions; and the processor is configured to read instructions from the memory and execute the instructions to implement the method for picking goods according to the first aspect above.

According to a third aspect of embodiments of the present disclosure, a non-transitory computer-readable storage medium is provided, in which computer instructions are stored. The computer instructions are configured to enable the computer to execute the method for picking goods according to the first aspect above.

### BRIEF DESCRIPTION OF THE DRAWINGS

In order to clearly illustrate the technical solutions in embodiments of the present disclosure, the accompanying drawings to be used in description for the embodiments will be briefly introduced below. Apparently, the drawings in the following description only show some embodiments of the present disclosure. For those skilled in the art, other drawings may also be obtained according to these drawings without any creative effort.

FIG. 1 is a schematic diagram of a goods picking scenario according to embodiments of the present disclosure;

FIG. 2 is a schematic diagram of another goods picking scenario according to embodiments of the present disclosure;

FIG. 3A is a schematic diagram of a warehouse system according to embodiments of the present disclosure;

FIG. 3B is a schematic diagram of a method for picking goods according to embodiments of the present disclosure;

FIG. 4A is a schematic diagram of another method for picking goods according to embodiments of the present disclosure;

FIG. 4B is a schematic diagram of yet another method for picking goods according to embodiments of the present disclosure;

FIG. 5 is a schematic diagram of yet another method for picking goods according to embodiments of the present disclosure;

FIG. 6 is a schematic diagram of yet another method for picking goods according to embodiments of the present disclosure;

FIG. 7 is a schematic diagram of yet another method for picking goods according to embodiments of the present disclosure;

FIG. 8 is a schematic diagram of yet another method for picking goods according to embodiments of the present disclosure;

FIG. 9 is a schematic diagram of yet another method for picking goods according to embodiments of the present disclosure;

FIG. 10 is a schematic diagram of yet another method for picking goods according to embodiments of the present disclosure;

FIG. 11 is a schematic diagram of an apparatus for picking goods according to embodiments of the present disclosure;

FIG. 12 is a schematic diagram of an electronic device according to embodiments of the present disclosure; and

FIG. 13 is a schematic diagram of another electronic device according to embodiments of the present disclosure.

### DETAILED DESCRIPTION

In order to enable those skilled in the art to better understand the technical solutions in embodiments of the present disclosure and to make the above purposes, features and advantages of embodiments of the present disclosure more clear and understandable, the technical solutions in embodiments of the present disclosure are further described in detail below with reference to the accompanying drawings.

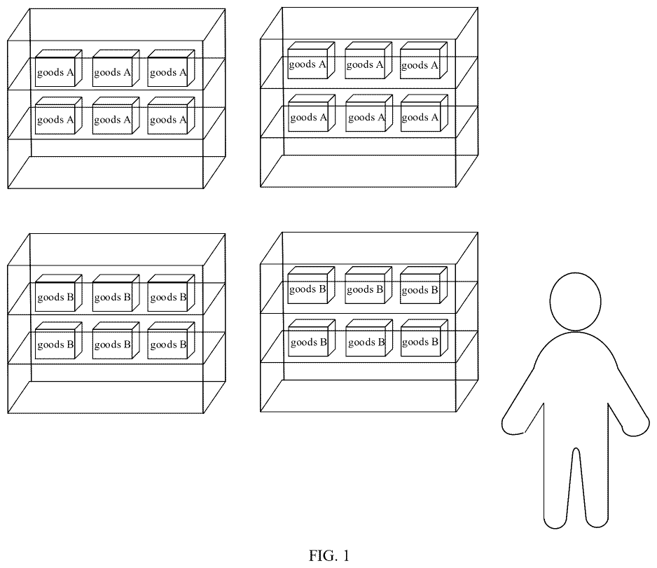

FIG. 1 is a schematic diagram of a goods picking scenario according to embodiments of the present disclosure. For example, FIG. 1 shows a schematic diagram of a scenario of “person-to-goods” picking mode in the related art. In the “person-to-goods” picking mode, a picker needs to move to a shelf position corresponding to selected goods, take out the goods, and take the goods to a workstation for picking.

To improve a picking efficiency, the same goods may be placed together on one or more shelves. As shown in FIG. 1, goods A may be placed together on two shelves, and goods B may be placed together on another two shelves. By placing the same type of goods together, it may be ensured that when picking the same type of goods, the path is basically fixed and the picker do not need to take too many detours. Although the picking efficiency may be improved by optimizing positions of goods and optimizing picking paths in the “person-to-goods” picking mode, this picking mode cannot meet the requirements of the warehouse system for the picking efficiency in a case where the warehouse is large and many types of goods exist in the warehouse.

With the continuous development of the robot field, the “person-to-goods” picking mode is gradually transformed into a “goods-to-person” picking mode.

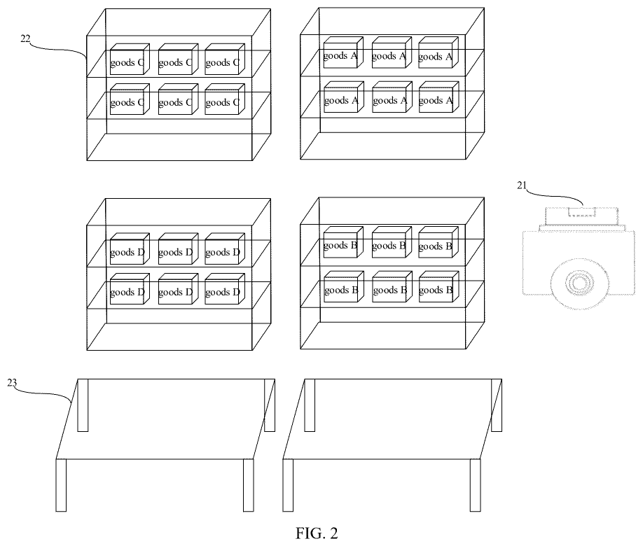

FIG. 2 is a schematic diagram of another goods picking scenario according to embodiments of the present disclosure. For example, FIG. 2 shows a schematic diagram of a scenario of “goods-to-person” picking mode in the related art. In the “goods-to-person” picking mode, automated sorting devices such as robots (e.g., shuttle vehicles) may be used to transport goods in large-scale stereoscopic warehouses (such as warehouses). Compared with the “person-to-goods” picking mode in FIG. 1, the “goods-to-person” picking mode has a higher picking efficiency.

As shown in FIG. 2, in the “goods-to-person” picking mode, a robot 21 may travel to a position of a shelf 22 to pick up goods placed on the shelf 22 and transport the goods to a workstation 23; or a robot 21 may transport goods from the workstation 23 to the position of the shelf 22 to place the goods on the goods position of the shelf 22.

For example, in the “goods-to-person” picking mode, the robot 21 may only transport goods at one shelf position at a time. Each shelf 22 usually stores one type of goods. The robot 21 needs to select the shelf 22 closest to the workstation 23 one by one according to goods required on an order, and take out corresponding goods. Therefore, in the “goods-to-person” picking mode, in a case where an order requires many types of goods and positions of different types of goods are relatively scattered, the robot 21 needs to run multiple times to different goods positions to complete goods picking required for the order.

In some examples, in the “goods-to-person” picking mode, when the electronic device for assigning tasks obtains a batch of orders, it first determines a workstation corresponding to each order, and then assigns transport tasks corresponding to each goods in the order to robots. The robot transports an inventory receptacle containing the goods corresponding to the order to the workstation according to the transport task. That is, in the related art, an inventory receptacle may be pre-specified for each goods in all orders, and then a transport task may be generated and sent to a specified robot. The specified robot may transport the specified inventory receptacle to the workstation, so that the staff may pick the goods in the inventory receptacle to realize goods picking.

In some examples, orders with more goods require more robots, but the number of robots in the warehouse is limited. In the related art, when assigning a robot to a transport task corresponding to an order, unreasonable assignment may occur, resulting in a longer time consumption for the goods picking process. For example, the electronic device may assign more transport tasks to some robots and fewer transport tasks to some other robots, or assign no transport tasks to some other robots, so that the robots assigned with fewer transport tasks or no transport tasks may be in an idle state, while the robots assigned with more transport tasks are always in a working state, thereby reducing the work efficiency of the robots and reducing the efficiency of goods picking. Alternatively, the electronic device may assign the transport task to a robot that is far away from the workstation or inventory receptacle, so that the robot needs to travel a longer path for transporting the goods, thereby increasing the time for goods picking and reducing the efficiency of goods picking.

In some other examples, in the related art, when specifying inventory receptacles for goods required for an order, a situation of unreasonable assignment may occur. For example, a pre-specified inventory receptacle may be far away from a robot performing the transport task, while there may exist an inventory receptacle corresponding to the goods near the robot. In this case, the robot needs to travel to the farther inventory receptacle to transport the inventory receptacle, which causes the goods picking process to take a longer time and reduces the efficiency of goods picking.

In order to solve the above problems, embodiments of the present disclosure provide a method and apparatus for picking goods, an electronic device and a readable storage medium. The method for picking goods determines a target workstation for each piece of first order information from workstations corresponding to various orders in a case where obtained orders include at least one piece of first order information; obtains robot parameter information of each robot in the warehouse and an inventory receptacle parameter of each inventory receptacle corresponding to the first order information; and determines a target robot from a plurality of robots and determines a target inventory receptacle from a plurality of inventory receptacles according to the robot parameter information of each robot and/or the inventory receptacle parameter of each inventory receptacle. Furthermore, a goods picking task is generated according to the first order information and the target inventory receptacle, and the goods picking task is sent to the target robot to make the target robot transport the target inventory receptacle to a target workstation according to the goods picking task. Each piece of first order information indicates a type of goods to be picked for which an inventory receptacle is not specified. The method for picking goods according to embodiments of the present disclosure is different from the related art in which robots and inventory receptacles are pre-specified for each piece of order information. For goods for which an inventory receptacle and robot are not specified, the target inventory receptacle and the target robot to perform the goods picking task are determined in real time for the first order information according to the robot parameter information and the inventory container parameter, and the goods picking task that conforms to an actual situation and is relatively reasonable is generated, thereby shortening the time of the goods picking process and improving the efficiency of goods picking.

Before describing the technical solutions of embodiments of the present disclosure, an application scenario of embodiments of the present disclosure is first described with reference to the accompanying drawings.

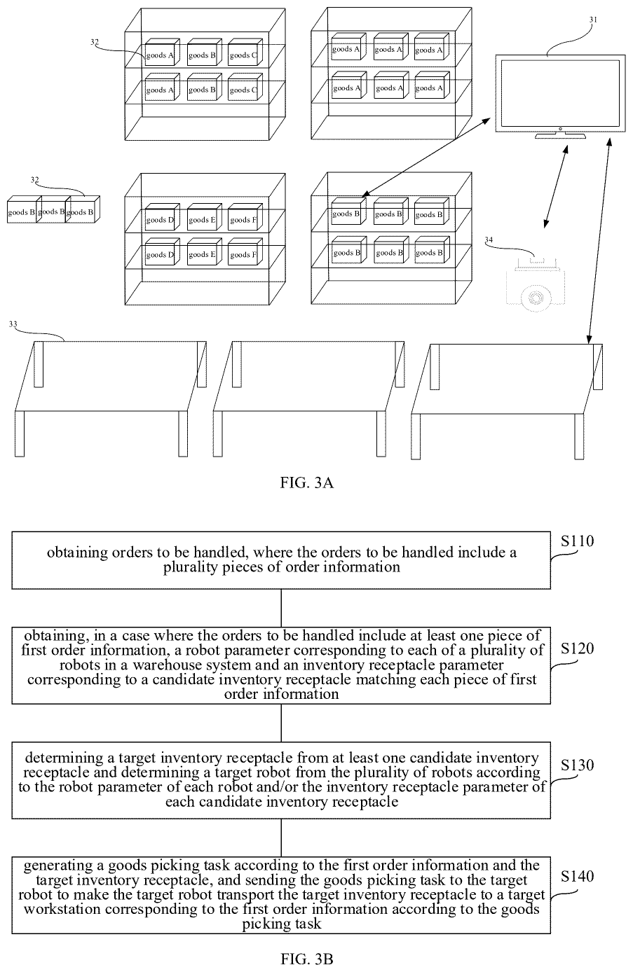

FIG. 3A is a schematic diagram of a warehouse system according to embodiments of the present disclosure. As shown in FIG. 3A, the warehouse system 1 may include an electronic device 31, a plurality of inventory receptacles 32, a workstation 33, and a robot 34.

For example, the warehouse system 1 may further include a holder for placing the inventory receptacle, and the holder may include a shelf, a bin, etc. The inventory receptacle may be placed on the holder, or the inventory receptacle may be placed directly on a floor of the warehouse, which is not limited in embodiments of the present disclosure. It should be noted that the number of inventory receptacles 32, the number of robots 34, and the number of workstations 33 in the warehouse system 1 may be set as required, which are not limited in embodiments of the present disclosure.

In some examples, the workstation 33 and the robot 34 may respectively communicate with the electronic device 31 via a network. For example, the electronic device 31 may include a server or a terminal. The terminal may include at least one of: a personal computer, a laptop computer, a smart phone, a tablet computer or a portable wearable device; and the server may include an independent server or a server cluster composed of a plurality of servers, which are not limited in embodiments of the present disclosure.

In some examples, the robot 34 is configured to perform the goods transport task sent by the electronic device 31. For example, the electronic device 31 may generate a corresponding transport task according to an obtained order and send the transport task to the robot 34. The robot 34 transports the inventory receptacle 32 corresponding to the order to the workstation according to the transport task for a goods picking operation. The workstation 33 is a place for performing the goods picking operation, and the inventory receptacle 32 is a receptacle for storing the goods.

In some examples, different goods (or commodities) may be stored in different inventory receptacles respectively, and the same type of goods may also be stored in different inventory receptacles. For example, a plurality of inventory receptacles storing the same type of goods may be dispersedly placed in the warehouse (e.g., on storage shelves, on the ground, in bins), that is, the same type of goods may be distributed in a plurality of inventory receptacles in the warehouse.

For example, after obtaining an order, the electronic device 31 may allocate corresponding workstations, inventory receptacles, and robots for a part of the goods in the order, and not specify corresponding workstations, robots, and inventory receptacles for another part of the goods.

In some embodiments, in a case where the order obtained by the electronic device 31 include at least one piece of first order information, that is, the order includes to-be-picked goods for which an inventory receptacle is not specified, the electronic device 31 may obtain a robot parameter of each of a plurality of robots 34 in the warehouse system 1 and an inventory receptacle parameter corresponding to a candidate inventory receptacle matching the first order information; determine a target inventory receptacle from at least one candidate inventory receptacle and determine a target robot from the plurality of robots according to the robot parameter of each robot and/or the inventory receptacle parameter of each inventory receptacle; generate a goods picking task according to the first order information and the target inventory receptacle, and send the goods picking task to the target robot to make the target robot transport the target inventory receptacle to a target workstation corresponding to the first order information according to the goods picking task.

The method for picking goods according to embodiments of the present disclosure is described in detail below with reference to the accompanying drawings.

FIG. 3B is a schematic diagram of a method for picking goods according to embodiments of the present disclosure. For example, the method shown in FIG. 3B may be performed by the electronic device 31 in the above embodiments. As shown in FIG. 3B, the method may include S110 to S140 as shown below.

In S110, orders to be handled are obtained, and the orders to be handled include a plurality pieces of order information.

For example, the orders to be handled (hereinafter may also be referred to as orders) may be issued in batches or individually. That is, the electronic device may obtain a plurality of orders to be handled at one time, or may obtain a plurality of orders to be handled at one time, which is not limited in embodiments of the present disclosure.

In some examples, each piece of order information may include information of at least one to-be-picked goods. For example, among the plurality pieces of order information in the orders to be handled, for the to-be-picked goods corresponding to some pieces of order information, inventory receptacles and robots have been specified, while for the to-be-picked goods corresponding to other pieces of order information, inventory receptacles and robots have not been specified.

In some examples, after obtaining the orders, each order may be subjected to an order assigning operation. The order assigning operation refers to assigning each order to a corresponding workstation.

For example, when the electronic device obtains the orders, it may first classify goods required in each order, select some goods from a plurality of goods corresponding to each order, and specify corresponding inventory receptacles and corresponding robots for the selected goods.

For example, the above process may be called partial order assigning operation. That is, corresponding workstations, inventory receptacles, and robots are specified for a part of the goods corresponding to the order to perform the goods picking operation. For another part of the goods, inventory receptacles and robots are not specified.

In some examples, a specified robot may move to a position of a specified inventory receptacle and transport the specified inventory receptacle to a workstation corresponding to the goods. For example, the selected goods may be selected randomly or according to a preset rule, which is not limited in embodiments of the present disclosure.

In S120, in a case where the orders to be handled include at least one piece of first order information, a robot parameter corresponding to each of a plurality of robots in a warehouse system and an inventory receptacle parameter corresponding to a candidate inventory receptacle matching each piece of first order information are obtained.

For example, if an order to be handled includes at least one piece of first order information, it indicates that the order is an order to be subjected to a partial order assigning operation, and the goods corresponding to the order include goods for which an inventory receptacle and a robot are not specified.

In some examples, the first order information indicates to-be-picked goods for which an inventory receptacle is not specified. For the to-be-picked goods corresponding to the first order information, a robot and a workstation may also not be specified.

In some embodiments, after step 120, the method may further include: determining a target workstation corresponding to the first order information from a plurality of workstations in the warehouse system according to the first order information, in the case where the orders to be handled include at least one piece of first order information.

The target workstation is a workstation where the picking operation needs to be performed on the to-be-picked goods corresponding to the first order information.

In some embodiments, determining the target workstation corresponding to the first order information from the plurality of workstations in the warehouse system according to the first order information includes: obtaining a workload of each of the plurality of workstations; and determining, from the plurality of workstations, a workstation with a workload less than a preset workload threshold or a workstation with a smallest workload as the target workstation.

In some examples, when it is determined that at least one piece of first order information exists, the target workstation may be determined for each piece of first order information in a priority order of the at least one piece of first order information, and for each piece of first order information, the target workstation may be determined according to a current workload (also referred to as task amount) of each workstation.

For example, the preset workload threshold may be set as demanded. For example, the preset workload threshold may be a smaller workload value. In a case where a workload of a workstation is less than the preset workload threshold, it indicates that this workstation has less workload, so determining this workstation as the target workstation may improve the efficiency of goods picking. Alternatively, the workstation with the smallest workload among the plurality of workstations may be directly determined as the target workstation.

In some other examples, in a case where there are pickers at workstations to perform the goods picking operation, a workstation with the largest number of pickers may be determined as the target workstation according to the number of pickers at each workstation.

In some other examples, a workstation with the smallest workload and the most pickers among the plurality of workstations may be determined as the target workstation.

For example, after determining the target workstation, for the first order information corresponding to the target workstation, a pool of candidate inventory receptacles corresponding to each piece of first order information may be constructed. The pool of candidate inventory receptacles may include candidate inventory receptacles corresponding to the first order information. The candidate inventory receptacle is the one of the plurality of inventory receptacles in the warehouse system that stores the to-be-picked goods corresponding to the first order information.

In some embodiments, before determining the target workstation, the method for picking goods may further include: obtaining a state of each of the plurality of robots; and determining the target workstation corresponding to the first order information from the plurality of workstations in the warehouse system in a case where a robot in an idle state exists in the plurality of robots.

The state of the robot includes the idle state and a non-idle state (also called a working state).

In some examples, the state of the robot indicates whether the robot is performing a task. In a case where the robot is performing a task, the state of the robot is the non-idle state or the working state, and the robot may also be called a non-idle robot; and in a case where the robot does not perform a task, the state of the robot is the idle state, and the robot may also be called an idle robot.

In some examples, the electronic device 31 may obtain the state of all robots in the warehouse system 1, and when it is determined that a robot in the idle state exists, the step of determining the target workstation may be performed.

For example, a robot state statistics table may be set according to the state of each robot, and the state of respective robots in the robot state statistics table may be updated according to real-time state information of the robots, so that the state of each robot may be obtained according to the robot state statistics table.

For example, when it is determined that each robot is in the working state, the target workstation is not determined temporarily. Until a robot in the idle state exists in the plurality of robots, the operation of determining the target workstation is performed.

For example, in a case where no robot in the idle state exists in the plurality of robots, a task amount of each robot may be obtained. In a case where there exists a robot with a task amount less than a preset workload threshold, the step of determining the target workstation may be performed.

In embodiments of the present disclosure, after the state of each robot in the warehouse (or warehouse system) is obtained, the target workstation is determined from the plurality of workstations according to the state of each robot, so that a workstation where goods picking needs to be performed is determined in real time in a case where the idle robot exists, and subsequently, the idle robot can be driven to perform a task, saving the time for goods picking.

In some embodiments, the robot parameter may include at least one of: position information of the robot, a state of the robot, a distance between the robot and each inventory receptacle, or a distance between the robot and each workstation, etc., which is not limited in embodiments of the present disclosure.

In some embodiments, the inventory receptacle parameter may include at least one of: the number and weight of goods stored in the inventory receptacle, position information of the inventory receptacle, or a matching degree of the inventory receptacle, which is not limited in embodiments of the present disclosure. For example, the pool of candidate inventory receptacles may include the inventory receptacle parameter corresponding to each inventory receptacle.

In S130, a target inventory receptacle is determined from at least one candidate inventory receptacle and a target robot is determined from the plurality of robots according to the robot parameter of each robot and/or the inventory receptacle parameter of each candidate inventory receptacle.

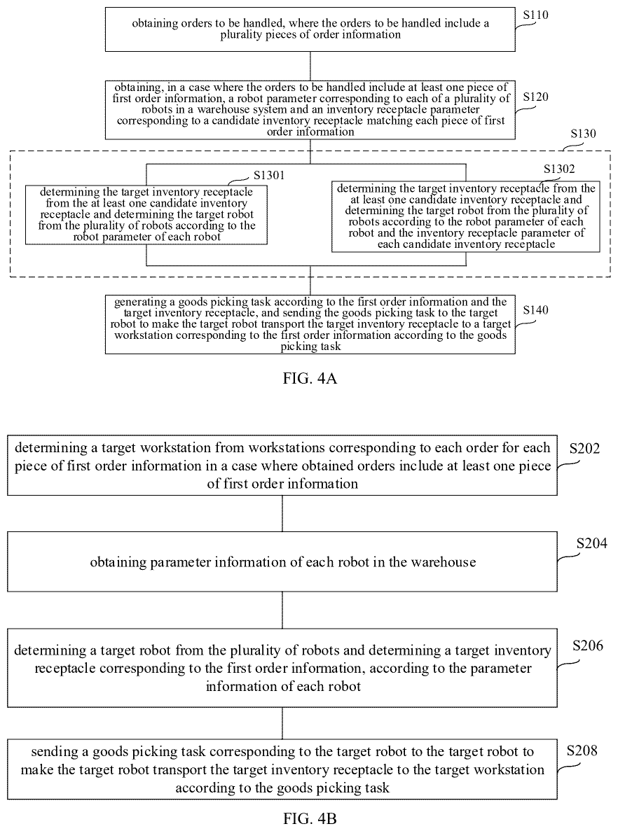

FIG. 4A is a schematic diagram of another method for picking goods according to embodiments of the present disclosure. As shown in FIG. 4A, the above S130 may include S1301 to S1302 as shown below.

In S1301, the target inventory receptacle is determined from the at least one candidate inventory receptacle and the target robot is determined from the plurality of robots according to the robot parameter of each robot.

In S1302, the target inventory receptacle is determined from the at least one candidate inventory receptacle and the target robot is determined from the plurality of robots according to the robot parameter of each robot and the inventory receptacle parameter of each candidate inventory receptacle.

In S140, a goods picking task is generated according to the first order information and the target inventory receptacle, and the goods picking task is sent to the target robot to make the target robot transport the target inventory receptacle to a target workstation corresponding to the first order information according to the goods picking task.

After determining the target inventory receptacle and the target robot through the above step S130, the electronic device may generate a corresponding goods picking task according to the first order information and the target inventory receptacle, and send the corresponding goods picking task to the target robot. The target robot receives the goods picking task, moves to a position of the target inventory receptacle according to the goods picking task, and transports the target inventory receptacle to the target workstation.

The goods picking process in a case where the target inventory receptacle and the target robot are determined according to the robot parameter of each robot as described in the above step S1301 will be described below with reference to the accompanying drawings.

FIG. 4B is a schematic diagram of yet another method for picking goods according to embodiments of the present disclosure. The method may be performed by the electronic device in the above embodiments. As shown in FIG. 4B, the method for picking goods may include S202 to S208 as shown below.

In S202, a target workstation is determined for the first order information from workstations corresponding to obtained orders in a case where the obtained orders include at least one piece of first order information.

It should be noted that the process for determining the target workstation has been described in the above embodiments, which may not be elaborated here to avoid repetition.

In S204, robot parameter information of each robot in the warehouse is obtained.

In S206, a target robot is determined from the plurality of robots and a target inventory receptacle corresponding to the first order information is determined, according to the robot parameter information of each robot.

The robot parameter information of each robot may also be called a robot parameter.

In some examples, when the robot parameter of each robot is obtained, the target robot that needs to perform a task and the target inventory receptacle corresponding to the first order information may be determined, according to the robot parameter of each robot.

For example, after obtaining the state of each robot, a robot in an idle state may be regarded as a reference robot, and a distance between each reference robot and each inventory receptacle (i.e., candidate inventory receptacle) in the pool of candidate inventory receptacles corresponding to the first order information is determined, and an inventory receptacle with a closest distance is determined as the target inventory receptacle, and a corresponding reference robot is determined as the target robot.

In some embodiments, determining the target inventory receptacle from the at least one candidate inventory receptacle and determining the target robot from the plurality of robots according to the robot parameter of each robot include: determining a target traveling path of each robot according to the robot parameter of each robot; and determining the target robot and the target inventory receptacle according to the target traveling path of each robot.

In some examples, the target traveling path is a partial or complete traveling path of each robot for transporting the candidate inventory receptacle.

FIG. 5 is a schematic diagram of yet another method for picking goods according to embodiments of the present disclosure. As shown in FIG. 5, the above S206 may include S2062 to S2064 as shown below.

In S2062, a target traveling path for each robot to obtain the inventory receptacle corresponding to the first order information is determined according to the parameter information of each robot.

The target traveling path is a partial or complete traveling path of each robot in the process of transporting the inventory receptacle (i.e., the candidate inventory receptacle) corresponding to the first order information.

In some examples, the target traveling path may include a path for the robot to obtain the candidate inventory receptacle (also called the partial traveling path), or the target traveling path may include a traveling path for the robot to obtain the candidate inventory receptacle and transport the candidate inventory receptacle to the target workstation (also called the complete traveling path). The partial path may include a traveling path for the robot to obtain the candidate inventory receptacle, and/or a traveling path for the robot to run from a position of the candidate inventory receptacle to a position of the target workstation, which is not limited here.

In some examples, the target traveling path of each robot to each candidate inventory receptacle may be determined according to position information of each robot and position information of each inventory receptacle (i.e., the candidate inventory receptacle) in the pool of candidate inventory receptacles corresponding to the first order information.

For example, in a case where obtained robot parameters are different, the target traveling paths determined by the electronic device may be different. A process for determining target traveling paths corresponding to different robot parameters is described below.

In some embodiments, in a case where the robot parameter includes a state and position information of the robot, determining the target traveling path of each robot according to the robot parameter of each robot includes: determining a robot in an idle state from the robots as a first candidate robot according to the state of each robot; and determining a target traveling path of the first candidate robot according to position information of the first candidate robot.

For example, in a case where the robot parameter is the state and the position information of the robot, the target traveling path may be determined according to the state and the position information of the robot.

In some examples, after obtaining the state of each robot, the robot in the idle state is determined as the first candidate robot. According to position information of each first candidate robot (such as a position where the first candidate robot is located), position information of each candidate inventory receptacle, and position information of the target workstation, a complete traveling path for the first candidate robot to run to the candidate inventory receptacle and transport the candidate inventory receptacle to the target workstation is determined as the target traveling path; or a partial traveling path for the first candidate robot to run to the candidate inventory receptacle may be determined as the target traveling path.

In embodiments of the present disclosure, an idle robot is determined as the candidate robot according to the state of each robot in the warehouse, and then the target traveling path for the first candidate robot to obtain each inventory receptacle is determined according to the position of the first candidate robot. In this way, in a case where the idle robot is determined, the traveling path of the robot that can be used to perform the task may be determined in real time, so that goods picking tasks may be planed reasonably, thereby saving the time for goods picking, increasing the rationality of task assignment, reducing the time for goods picking, and improving the efficiency of goods picking.

In some embodiments, in a case where the robot parameter includes an idle time and position information of the robot, determining the target traveling path of each robot according to the robot parameter of each robot includes: determining, from the plurality of robots, a robot with an idle time greater than a preset time threshold or a robot with a longest idle time as a second candidate robot according to the idle time of each robot; and determining a target traveling path of the second candidate robot according to position information of the second candidate robot.

For example, in a case where the robot parameter includes the idle time and the position information of the robot, the target traveling path may be determined according to the idle time and the position information of the robot. The position information of the robot may include a current position of the robot.

The idle time of the robot is a time from a moment when the robot completes the last task to a current moment when no task is performed by the robot.

In some examples, after obtaining the idle time of each robot, the robot with the longest idle time may be determined as the second candidate robot; or the robot with the idle time greater than the preset time threshold may be determined as the second candidate robot. The preset time threshold may be set as demanded.

In some examples, after determining the second candidate robot, according to position information of the second candidate robot, position information of each candidate inventory receptacle, and position information of the target workstation, a complete traveling path for the the second candidate robot to run to the candidate inventory receptacle and transport the candidate inventory receptacle to the target workstation may be determined as the target traveling path; or a partial traveling path for the second candidate robot to run to the candidate inventory receptacle may be determined as the target traveling path.

In embodiments of the present disclosure, the robot with the longest idle time among the plurality of robots is determined as the second candidate robot, and the target traveling path of the second candidate robot is determined according to the position of the second candidate robot. In this way, the robots may be dispatched in real time to perform tasks with the reasonable consideration of the idle situation of robots, so as to save the time for picking goods and increase the rationality of task assignment.

In some embodiments, in a case where the robot parameter includes a workload and position information of the robot, determining the target traveling path of each robot according to the robot parameter of each robot include: determining, from the plurality of robots, a robot with a workload less than a preset workload threshold or a robot with a smallest workload as a third candidate robot according to the workload of each robot; and determining a target traveling path of the third candidate robot according to position information of the third candidate robot.

In some examples, after obtaining the workload of each robot, the robot with the smallest workload may be determined as the third candidate robot, or the robot with the workload less than the preset workload threshold may be determined as the third candidate robot. The preset workload threshold may be set as demanded.

In some examples, after determining the third candidate robot, according to position information of the third candidate robot, position information of each candidate inventory receptacle, and position information of the target workstation, a complete traveling path for the third candidate robot to run to the candidate inventory receptacle and pick up the candidate inventory receptacle to the target workstation may be determined as the target traveling path; or a partial traveling path for the third candidate robot to run to the candidate inventory receptacle may be determined as the target traveling path.

In embodiments of the present disclosure, the robot with the smallest workload among the plurality of robots is determined as the third candidate robot, and the target traveling path of the third candidate robot is determined according to the position of the third candidate robot. In this way, the workloads of robots may be reasonably considered to balance the actual workload of each robot, so as to save the time for picking goods, and increase the rationality of task assignment.

In S2064, the target inventory receptacle corresponding to the first order information and the target robot are determined according to the target traveling path.

The at least one candidate inventory receptacle corresponding to the first order information includes the target inventory receptacle.

In some embodiments, determining the target robot and the target inventory receptacle according to the target traveling path of each robot includes: determining a robot with a shortest target traveling path or a robot with a target traveling path less than a preset path length threshold as the target robot according to the target traveling path of each robot; and determining the target inventory receptacle according to a distance between the target robot and each candidate inventory receptacle.

In some examples, a distance between the target robot and the target inventory receptacle is less than a distance between the target robot and other candidate inventory receptacles.

In some examples, after determining the target traveling path, the candidate robot with the shortest target traveling path may be determined as the target robot, or the robot with the target traveling path less than the preset path length threshold may be determined as the target robot; at the same time, a candidate inventory receptacle corresponding to the shortest target traveling path may be determined as the target inventory receptacle.

For example, n candidate robots with the shortest target traveling path may be determined as target robots, where n is a positive integer. The target inventory receptacles are determined according to the target robots. The distance between the target robot and the target inventory receptacle is less than the distance between the target robot and other candidate inventory receptacles.

In some examples, after obtaining each target traveling path corresponding to each candidate robot, at least one shortest path may be determined from the target traveling paths. The candidate robots corresponding to respective shortest paths are the target robots. The candidate inventory receptacle to be obtained by the corresponding target robot is the target inventory receptacle. The candidate robots may include at least one of: the first candidate robot, the second candidate robot or the third candidate robot.

In some examples, after determining the target robot, the distance between the target robot and each candidate inventory receptacle may be further determined, and a candidate receptacle with a shortest distance to the target robot may be determined as the target inventory receptacle. The candidate inventory receptacle with the shortest distance to the target robot and the candidate inventory receptacle corresponding to the shortest target traveling path are the same inventory receptacle.

In embodiments of the present disclosure, the candidate robot with the shortest target traveling path is determined as the target robot. After the target robot is determined, since the distance between the target robot and the target inventory receptacle is less than the distance between the target robot and other inventory receptacles, the target inventory receptacle may be determined, thus saving the traveling time of the robot to acquire and transport the inventory receptacle to the target workstation.

In S208, a goods picking task corresponding to the target robot is sent to the target robot to make the target robot transport the target inventory receptacle to the target workstation according to the goods picking task.

In some examples, the electronic device may generate the goods picking task according to the first order information, the target workstation, and the target inventory receptacle, and send the goods picking task to the target robot to make the target robot transport the target inventory receptacle to the target workstation according to the goods picking task to complete an operation for picking goods.

In embodiments of the present disclosure, the robot parameter of each robot in the warehouse is obtained, the target robot is determined from the plurality of robots according to the robot parameter of each robot, and the target inventory receptacle is determined from inventory receptacles corresponding to the first order information. Furthermore, the goods picking task corresponding to the target robot is sent to the target robot to make the target robot transport the target inventory receptacle to the target workstation according to the goods picking task. Compared with the related art in which robots and inventory receptacles are pre-specified for each piece of order information, embodiments of the present disclosure may, for goods for which the inventory receptacle and the robot are not specified, adjust the inventory receptacle corresponding to the first order information and the robot for performing the goods picking task in real time according to the robot parameter, and generate a goods picking task that conforms to an actual situation and is relatively reasonable, thereby shortening the time of the goods picking process.

In embodiments of the present disclosure, the target workstation that needs to perform the picking task may be determined for each piece of first order information for which the inventory receptacle is not specified, so that the picking workload of the workstation may be reasonably assigned and the waiting time of the goods at the workstation may be shortened. Further, the target robot for performing the goods picking corresponding to the first order information is determined, and the most reasonable inventory receptacle is obtained, which are more in line with the actual situation of the robot during the work process, and the most reasonable inventory receptacle is assigned, which may greatly save the time of the robot to obtain the inventory receptacle, shorten the time of entire goods picking process, and save running resources of the robot.

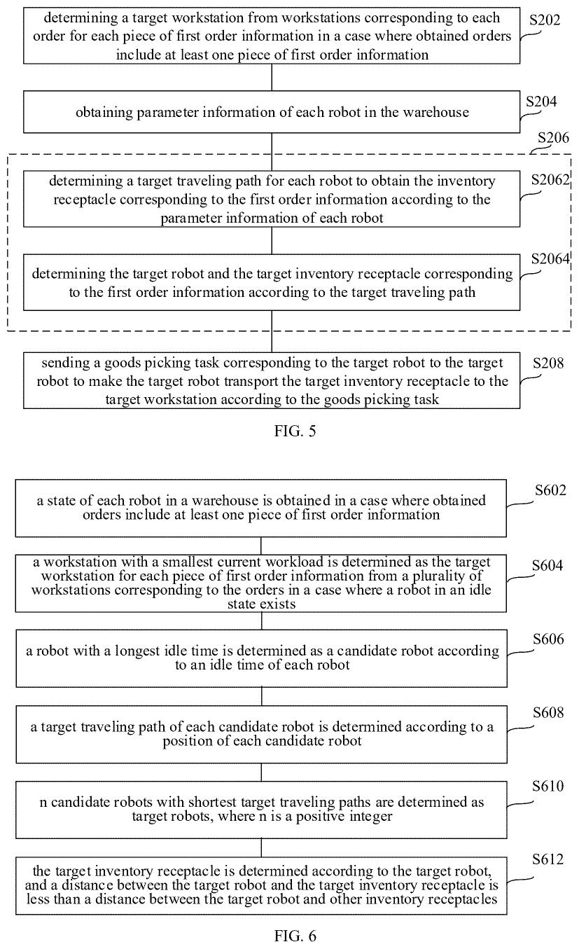

FIG. 6 is a schematic diagram of yet another method for picking goods according to embodiments of the present disclosure. The goods picking process in a case where the target robot and the target inventory receptacle are determined according to the robot parameter information may be described below with reference to FIG. 6. As shown in FIG. 6, the method for picking goods includes the following steps.

In S602, a state of each robot in the warehouse is obtained in a case where the obtained orders include at least one piece of first order information.

In S604, a workstation with a smallest current workload is determined as the target workstation for each piece of first order information from a plurality of workstations corresponding to the orders in a case where a robot in an idle state exists.

In S606, a robot with a longest idle time is determined as a candidate robot according to an idle time of each robot.

In S608, a target traveling path of each candidate robot is determined according to a position of each candidate robot.

In S610, n candidate robots with shortest target traveling paths are determined as target robots, where n is a positive integer.

In S612, the target inventory receptacle is determined according to the target robot, and a distance between the target robot and the target inventory receptacle is less than a distance between the target robot and other inventory receptacles.

It should be noted that the processes of S602 to S612 have been described in detail in the above embodiments, and the effect that may be achieved by the method for picking goods shown in FIG. 6 is the same as the effect that may be achieved by the method for picking goods in the above embodiments, which will not be elaborated here to avoid repetition.

The goods picking process in a case where the target inventory receptacle and the target robot are determined according to the robot parameter of each robot and the inventory receptacle parameter of each candidate inventory receptacle as described in the above step S1302 will be described below with reference to the accompanying drawings.

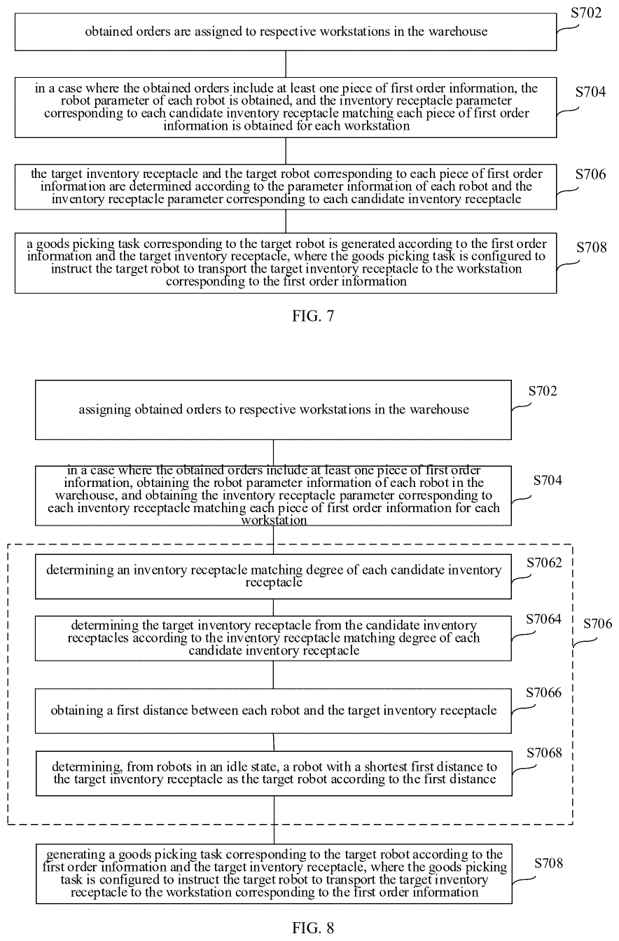

FIG. 7 is a schematic diagram of yet another method for picking goods according to embodiments of the present disclosure. The method may be performed by the electronic device in the above embodiments. As shown in FIG. 7, the method for picking goods may include the following steps.

In S702, orders obtained are assigned to respective workstations in the warehouse.

The workstation is a platform for picking the goods indicated by each piece of order information in each order. After obtaining the orders, the electronic device may assign a corresponding workstation for each order.

It should be noted that the determination of the workstation corresponding to each order in S702 is similar to the determination process of the target workstation in the above embodiments, which will not be elaborated here to avoid repetition.

In S704, in a case where the obtained orders include at least one piece of first order information, the robot parameter of each robot is obtained, and the inventory receptacle parameter corresponding to each candidate inventory receptacle matching each piece of first order information is obtained for each workstation.

In S706, the target inventory receptacle and the target robot corresponding to each piece of first order information are determined according to the robot parameter of each robot and the inventory receptacle parameter corresponding to each candidate inventory receptacle.

For example, the robot parameter may include at least one of: a state of the robot, an idle time of the robot, position information of the robot, or a distance from the robot to each workstation. The inventory receptacle parameter may include at least one of: an inventory receptacle matching degree, the number and weight of goods stored in the inventory receptacle, or position information of the inventory receptacle.

In some examples, after each order is assigned to the respective workstation, a pool of candidate inventory receptacles corresponding to each piece of first order information may be constructed for each piece of first order information corresponding to each workstation.

For example, in a case where the robot parameter of each robot and the inventory receptacle parameter corresponding to each candidate inventory receptacle are obtained, for each workstation, the robot with the smallest current workload may be determined as the target robot according to the current workload in the robot parameter of each robot, and then the candidate inventory receptacle with the highest inventory receptacle matching degree is determined as the target inventory receptacle according to the inventory receptacle matching degree in the inventory receptacle parameter of each candidate inventory receptacle. The first order information and a corresponding workstation are determined in a case where the target inventory receptacle is determined.

In some embodiments, in a case where the robot parameter includes the state of the robot, the step S706 includes: determining whether a robot in an idle state exists according to the state of each robot; and determining the target inventory receptacle and the target robot corresponding to each piece of first order information according to the robot parameter of each robot and the inventory receptacle parameter corresponding to each piece of first order information in the case where the robot in the idle state exists.

In some examples, in a case where the obtained robot parameter further includes the idle time of the robot, it may be determined for each robot whether its state is the idle state according to the state of each robot. In the case where the robot in the idle state exists, the robot with the longest idle time may be determined as the target robot according to the idle time of each robot in the idle state. When determining that the target robots are enough, the candidate inventory receptacle with the highest inventory receptacle matching degree may be determined as the target inventory receptacle according to the inventory receptacle matching degrees of all candidate inventory receptacles. It should be noted that the goods stored in the target inventory receptacle is known, so in a case where the target inventory receptacle is determined, the first order information and a corresponding workstation are determined.

In some embodiments, the robot parameter may include a first distance, and the inventory receptacle parameter includes an inventory receptacle matching degree. The target robot and the target inventory receptacle may be determined according to the first distance between each robot and each candidate inventory receptacle and the inventory receptacle matching degree of each candidate inventory receptacle.

FIG. 8 is a schematic diagram of yet another method for picking goods according to embodiments of the present disclosure. As shown in FIG. 8, the above S706 includes S7062 to S7068 as shown below.

In S7062, an inventory receptacle matching degree of each candidate inventory receptacle is determined.

For example, the inventory receptacle parameter includes the inventory receptacle matching degree, and the inventory receptacle matching degree indicates a matching status of the first order information with each candidate inventory receptacle.

In some examples, the inventory receptacle matching degree may be matching times of an inventory receptacle to the first order information in each order.

For example, order A includes goods 1, goods 2, and goods 3, and order B includes goods 1, goods 4, and goods 5; inventory receptacles a, b, and c all store goods 1, inventory receptacle d stores goods 2, and inventory receptacle e stores goods 3, goods 4, and goods 5. In a case where the first order information is goods 1, since goods 1 is matched to inventory receptacle a for twice, an inventory receptacle matching degree of inventory receptacle a corresponding to the first order information is 2.

In S7064, the target inventory receptacle is determined from the candidate inventory receptacles according to the inventory receptacle matching degree of each candidate inventory receptacle.

In some examples, the target inventory receptacle may be determined according to the inventory receptacle matching degree of each candidate inventory receptacle corresponding to the first order information.

In some embodiments, from the candidate inventory receptacles, a candidate inventory receptacle with a highest inventory receptacle matching degree may be determined as the target inventory receptacle.

In some examples, the candidate inventory receptacle with the highest inventory receptacle matching degree is selected from the candidate inventory receptacles as the target inventory receptacle, so that the inventory receptacle that meets the first order information may be accurately determined. That is, in a case where a plurality of orders include the first order information, an inventory container that can meet the first order information corresponding to more orders to a greatest extent in the once acquisition of the inventory container may be selected, thereby reducing the situation where the robot transports the inventory receptacle multiple times, reasonably assigning robots, and saving the time for picking goods out of the warehouse.

For example, the inventory receptacle parameter further includes the number of goods stored in the inventory receptacle.

For example, an inventory receptacle may store the same type of goods or different types of goods. In a case where the inventory receptacle stores the same type of goods, the number of the goods may be one or more. In a case where the inventory receptacle stores different types of goods, the number of each type of goods may be one or more, which is not limited in embodiments of the present disclosure.

In some examples, in a case where goods required by the first order information include a first type of goods, the candidate inventory receptacle corresponding to the first order information has stored therein the first type of goods, and the number of the first type of goods required by the first order information may be the same as or different from the number of the first type of goods stored in each candidate inventory receptacle.

For example, the candidate inventory receptacle with the highest inventory receptacle matching degree may correspond to a plurality pieces of first order information. In a case where the candidate inventory receptacle with the highest inventory receptacle matching degree may correspond to the plurality pieces of first order information, the number of the first type of goods stored in the candidate inventory receptacle with the highest inventory receptacle matching degree (i.e., alternative inventory receptacle) may or may not be able to meet the needs of the plurality pieces of first order information.

In some examples, the candidate inventory receptacle with the highest inventory receptacle matching degree may be referred to as the alternative inventory receptacle, the number of the first type of goods required by the plurality pieces of first order information may be referred to as a first number, and the number of the first type of goods stored in the alternative inventory receptacle may be referred to as a second number. For example, the number of the first type of goods stored in the alternative inventory receptacle may meet the number of the first type of goods required by the plurality pieces of first order information, that is, the first number is less than or equal to the second number; or the number of the first type of goods stored in the alternative inventory receptacle may not meet the number of the first type of goods required by the plurality pieces of first order information, that is, the first number is greater than the second number.

In some embodiments, in a case where the inventory receptacle parameter further includes the number of goods stored in the inventory receptacle, and the candidate inventory receptacle with the highest inventory receptacle matching degree corresponds to the plurality pieces of first order information, the above step S7064 may include: determining the number of the first type of goods required by each piece of first order information and the number of the first type of goods stored in the candidate inventory receptacle with the highest inventory receptacle matching degree; and determining the candidate inventory receptacle with the highest inventory receptacle matching degree as the target inventory receptacle in a case where the number of the first type of goods stored in the candidate inventory receptacle with the highest inventory receptacle matching degree is greater than or equal to the number of the first type of goods required by the plurality pieces of first order information.

In some examples, in a case where the number of the first type of goods stored in the candidate inventory receptacle with the highest inventory receptacle matching degree (i.e., the alternative inventory receptacle) may meet the number of the first type of goods required by the first order information, that is, the second number is greater than or equal to the first number, the alternative inventory receptacle may be directly determined as the target inventory receptacle, without further determining the target inventory receptacle.

In a case where the candidate inventory receptacle with the highest inventory receptacle matching degree is determined as the target inventory receptacle, and the number of goods stored in the target inventory receptacle cannot meet the number of goods required by the first order information of the orders at the corresponding workstation, it is necessary to further determine, from candidate inventory receptacles with the highest inventory receptacle matching degree, the target inventory receptacle corresponding to the first order information that may be met.

In some embodiments, in a case where the inventory receptacle parameter further includes the number of goods stored in the inventory receptacle, and the candidate inventory receptacle with the highest inventory receptacle matching degree corresponds to the plurality pieces of first order information, the above step S7064 may include: determining target order information according to the number of the first type of goods required by each piece of first order information and the number of the first type of goods stored in the candidate inventory receptacle with the highest inventory receptacle matching degree; and determining the target inventory receptacle according to the target order information.

In some embodiments, determining the target order information according to the number of the first type of goods required by each piece of first order information and the number of the first type of goods stored in the candidate inventory receptacle with the highest inventory receptacle matching degree includes: adding the number of the first type of goods required by multiple pieces of first order information to obtain a target number, in a case where the number of the first type of goods required by the plurality pieces of first order information is greater than the number of the first type of goods stored in the candidate inventory receptacle with the highest inventory receptacle matching degree; and determining each of the multiple pieces of first order information that are subjected to an addition operation as the target order information, in a case where the target number is less than the number of the first type of goods stored in the candidate inventory receptacle with the highest inventory receptacle matching degree.

In some examples, in a case where the number of the first type of goods required by the plurality pieces of first order information is greater than the number of the first type of goods stored in the candidate inventory receptacle, that is, the first number is greater than the second number, the candidate inventory receptacle cannot meet the requirements of the plurality pieces of first order information. In this case, it is necessary to re-determine the target order information from the plurality pieces of first order information. The number of the first type of goods required by the target order information may be met by the number of the first type of goods stored in the candidate inventory receptacle.

For example, for a workstation, if the number of the first type of goods stored in the candidate inventory receptacle with the highest inventory receptacle matching degree (i.e., the alternative inventory receptacle) is 8, and three pieces of first order information match with the candidate inventory receptacle, they are order p, order q, and order o, respectively. The number of the first type of goods required by order p is 2, the number of the first type of goods required by order q is 6, and the number of the first type of goods required by order o is 2. Therefore, the number (i.e., 8) of the first type of goods in the alternative inventory receptacle is less than a sum ((i.e., 10) of the number of the first type of goods required by order p, order q, and order o in the three pieces of first order information. That is, the first type of goods stored in the alternative inventory receptacle cannot meet the requirements of the three pieces of first order information for the the first type of goods.

In this case, the target order information needs to be determined from the plurality pieces of first order information.

In some embodiments, in the case where the number of the first type of goods required by the plurality pieces of first order information is greater than the number of the first type of goods stored in the candidate inventory receptacle with the highest inventory receptacle matching degree, the number of the first type of goods required by multiple pieces of first order information are added to obtain the target number; and in a case where the target number is less than or equal to the number of the first type of goods stored in the candidate inventory receptacle with the highest inventory receptacle matching degree, each of the multiple pieces of first order information that are subjected to the addition operation is determined as the target order information.

In some examples, in a case where a sum of the number of the first type of goods required by at least one of the plurality pieces of first order information (i.e., the target number) is less than or equal to the number of the first type of goods stored in the alternative inventory receptacle, each piece of first order information that is subjected to the addition operation is determined as the target order information.

In the above examples, since a sum of the number of the first type of goods required by order p and order q is 8, which is equal to the number of the first type of goods stored in the alternative inventory receptacle, the target order information may be order p and order q.

For example, the target order information is determined, which means that the first order information whose requirement for the number of goods is met is determined, and the target inventory receptacle for the first order information is determined.

In some examples, the target inventory receptacle may include an inventory receptacle that may meet the goods requirement of the target order information, and an inventory receptacle that meets other pieces of the plurality pieces of first order information than the target order information. For example, the target inventory receptacle may include an inventory receptacle that meets order p and order q and an inventory receptacle that meets order o.

For example, for the first order information (such as order o) whose requirement for the number of goods cannot be met, a corresponding pool of candidate inventory receptacles may be reconstructed, and a matched target inventory receptacle may be re-determined, and the determination process is similar to the above process of determining the target inventory receptacle, which may not be elaborated here to avoid repetition.

In embodiments of the present disclosure, in the case where the inventory receptacle with the highest inventory receptacle matching degree corresponds to at least two pieces of first order information, the target order information is determined according to the first number of goods required by each piece of first order information and the second number of goods stored in the target inventory receptacle, and the target inventory receptacle is determined according to the target order information. In this way, the first order information corresponding to as many orders as possible may be met to a greatest extent in the once acquisition process of the inventory receptacle by the robot, thereby reducing the situation where the robot transports the inventory receptacle multiple times, reasonably assigning robots, and saving the time for picking goods out of the warehouse.

In S7066, a first distance between each robot and the target inventory receptacle is obtained.

In some examples, the first distance is a distance from the robot to each inventory receptacle. For example, the first distance between each robot and each candidate inventory receptacle may be determined respectively according to position information of the robots and position information of each candidate inventory receptacle.

In S7068, among robots in the idle state, a robot with a shortest first distance to the target inventory receptacle is determined as the target robot according to the first distance.

In some examples, after determining the target inventory receptacle, the target robot may be determined from the robots in the idle state according to the position information of the target inventory receptacle. The target robot is the robot with the shortest first distance to the target inventory receptacle among idle robots. That is, the robot with the shortest first distance to the target inventory receptacle may be selected from the idle robots as the target robot corresponding to each piece of first order information.

In some embodiments, an idle robot with the shortest first distance to the target inventory receptacle is determined from the robots in the idle state as a target robot corresponding to the target order information according to the first distance.

For example, the robot with the shortest first distance to the target inventory receptacle is selected from the idle robots as the target robot corresponding to the target order information. In this way, the robot with the shortest distance to the target inventory receptacle may be selected, thereby reducing the situation where the robot takes detours, reducing the redundant time of the task, saving the time for picking goods out of the warehouse, and saving resources.

For example, in a case where a plurality of robots with the same and shortest first distance to the target inventory receptacle exist among the idle robots, an idle time of each robot may be further determined, and a robot with a longest idle time may be determined as the target robot. Alternatively, a robot may be randomly selected from the plurality of idle robots with the shortest first distance as the target robot, which is not limited in embodiments of the present disclosure.

In embodiments of the present disclosure, it is determined whether a robot in the idle state exists in the warehouse according to the state of each robot. In a case where the robot in the idle state exists, the target inventory receptacle and the target robot corresponding to each piece of first order information are determined according to the robot parameter of each robot and the inventory receptacle parameter corresponding to each piece of first order information. In this way, the idle robots may be reasonably assigned with the state of the robots being determined, and the target inventory receptacle to be obtained is determined, thereby saving the robot operation resources, and shortening the time for picking goods out of the warehouse.

In some embodiments, the robot parameter may include the first distance and a second distance, and the inventory receptacle parameter may include position information of the inventory receptacle. The above step S1302 may further include: determining each robot in the idle state as the target robot; determining a plurality of traveling paths for each target robot to transport each candidate inventory receptacle to the target workstation according to position information of each candidate inventory receptacle, and obtaining a plurality of groups of combined traveling paths by combining traveling paths for the target robots to transport candidate inventory receptacles corresponding to at least one piece of first order information; and determining a candidate inventory receptacle corresponding to each target robot in a combined traveling path with a shortest total traveling distance as the target inventory receptacle, according to the first distance between each target robot and each candidate inventory receptacle and the second distance between each candidate inventory receptacle and the target workstation.

The second distance is a distance between each candidate inventory receptacle and the target workstation. For example, after determining the target workstation, the second distance between each candidate inventory receptacle and the target workstation may be determined according to the position information of each candidate inventory receptacle and position information of the target workstation.

In some examples, a plurality of traveling paths for the target robot to move to the position of the candidate inventory receptacle corresponding to the first order information and transport the candidate inventory receptacle to the position of the target workstation may be determined according to the position information of each target robot, the position information of the target workstation, and the position information of each candidate inventory receptacle.

It should be noted that a plurality of traveling paths of one target robot for the first order information may be classified into a group of traveling paths, and groups of traveling paths of the target robots for the candidate inventory receptacles corresponding to at least one piece of first order information may be combined into a plurality of groups of combined traveling paths. Lengths of a plurality of traveling paths in the groups of combined traveling paths may be the same or different.

For example, a total traveling distance corresponding to each group of combined traveling paths may be determined according to the first distance between the target robot and the candidate inventory receptacle and the second distance between the candidate inventory receptacle and the target workstation. The total traveling distance may be a sum of distances of the plurality of traveling paths in each combined traveling path. The candidate inventory receptacle corresponding to each target robot in the combined traveling path with the shortest total traveling distance is determined as the target inventory receptacle.

In some examples, the robots in the idle state are determined as the target robots. A multiple-to-multiple matching is performed between the target robots and the inventory receptacles corresponding to the plurality pieces of first order information. Since each piece of first order information may correspond to a plurality of inventory receptacles, a plurality of traveling paths of each robot for one piece of first order information and a plurality of traveling paths of each robot for different pieces of first order information may be determined according to the distance between each target robot and each inventory receptacle corresponding to each piece of first order information and the distance between each inventory receptacle and the workstation. The traveling paths for the target robots to take the inventory receptacle corresponding to the respective one piece of first order information are combined to obtain a plurality of groups of combined traveling paths. The inventory receptacle corresponding to the respective first order information obtained by each target robot in the combined traveling path with the shortest total traveling distance is determined as the target inventory receptacle.

In embodiments of the present disclosure, a plurality of combined schemes for the idle target robots to obtain inventory receptacles corresponding to different pieces of first order information may be determined, from which a combined scheme corresponding to the shortest path is determined, and the target inventory receptacle to be obtained by the respective target robot may be determined. Since the workstation has been determined for the first order information when the order is assigned, the workstation is known, so the matched workstation, robot, and inventory receptacle may be directly determined, so that different robots may be simply and effectively assigned to perform different tasks with shortest traveling paths, which shortens the time for picking goods out of the warehouse and improves the efficiency of picking goods out of the warehouse.

In S708, a goods picking task corresponding to the target robot is generated according to the first order information and the target inventory receptacle, and the goods picking task is configured to instruct the target robot to transport the target inventory receptacle to the workstation corresponding to the first order information.

In some examples, the goods picking task is generated according to the first order information, the corresponding target workstation, and the target inventory receptacle, and is sent to the target robot to make the target robot transport the target inventory receptacle to the target workstation according to the goods picking task for the staff to pick the goods.

In embodiments of the present disclosure, the obtained orders are assigned to respective workstations in the warehouse. In the case where the obtained orders include at least one piece of first order information, robot parameter information of each robot in the warehouse is obtained, and for each workstation, the inventory receptacle parameter corresponding to each inventory receptacle matching each piece of first order information is obtained. According to the robot parameter information of each robot and the inventory receptacle parameter corresponding to each piece of first order information, the target inventory receptacle and the target robot corresponding to each piece of first order information are determined. The goods picking task corresponding to the target robot is generated according to the first order information and the target inventory receptacle, and the goods picking task is configured to instruct the target robot to transport the target inventory receptacle to the workstation corresponding to the first order information. Different from the related art in which robots and inventory receptacles are pre-specified for each piece of order information, since the first order information obtained in the present disclosure indicates goods for which the inventory receptacle and the robot are not specified, the inventory receptacle corresponding to the first order information and the robot for performing the goods picking task may be adjusted in real time according to the robot parameter information and the inventory receptacle parameter of each candidate inventory receptacle to generate the goods picking task that conforms to an actual situation and is relatively reasonable, thereby shortening the process time of picking goods out of the warehouse.

In embodiments of the present disclosure, for pieces of first order information for which the inventory receptacles are not specified, in a case where the idle robots exist, the multiple-to-multiple matching may be performed, so that a plurality of idle robots may transport a plurality of different inventory receptacles at the same time, that is, the plurality of idle robots may perform their respective tasks at the same time, saving the time for picking goods out of the warehouse. Moreover, since tasks are assigned in real time according to the robot parameter information and the inventory receptacle parameter of each candidate inventory receptacle, each piece of first order information may be optimally and reasonably matched to a robot and a corresponding inventory receptacle, thereby greatly saving the overall running resources of the robots and saving the time for performing the task.

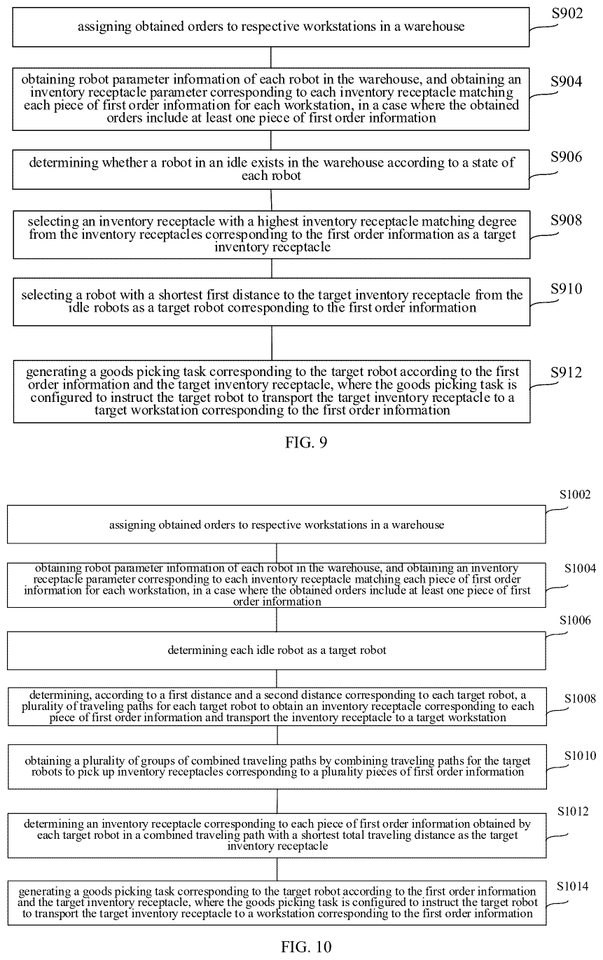

FIG. 9 is a schematic diagram of yet another method for picking goods according to embodiments of the present disclosure. A goods picking process in a case where a target robot and a target inventory receptacle are determined according to robot parameter information and an inventory receptacle parameter of each candidate inventory receptacle may be described below with reference to FIG. 9. As shown in FIG. 9, the method for picking goods includes the following steps.

In S902, obtained orders are assigned to respective workstations in a warehouse.

In S904, robot parameter information of each robot in the warehouse is obtained, and an inventory receptacle parameter corresponding to each inventory receptacle matching each piece of first order information is obtained for each workstation, in a case where the obtained orders include at least one piece of first order information.

In S906, whether a robot in an idle exists in the warehouse is determined according to a state of each robot.

In S908, an inventory receptacle with a highest inventory receptacle matching degree is selected from inventory receptacles corresponding to the first order information as a target inventory receptacle.

In S910, a robot with a shortest first distance to the target inventory receptacle is selected from the idle robots as a target robot corresponding to the first order information.

In S912, a goods picking task corresponding to the target robot is generated according to the first order information and the target inventory receptacle, and the goods picking task is configured to instruct the target robot to transport the target inventory receptacle to a target workstation corresponding to the first order information.

It should be noted that the processes of S902 to S912 have been described in detail in the above embodiments, and the effect achievable by the method for picking goods shown in FIG. 9 is the same as the effect achievable by the method for picking goods in the above embodiments, which will not be elaborated here to avoid repetition.

FIG. 10 is a schematic diagram of yet another method for picking goods according to embodiments of the present disclosure. Another goods picking process in a case where a target robot and a target inventory receptacle are determined according to robot parameter information and an inventory receptacle parameter of each candidate inventory receptacle may be described below with reference to FIG. 10. As shown in FIG. 10, the method for picking goods includes the following steps.

In S1002, obtained orders are assigned to respective workstations in a warehouse.

In S1004, robot parameter information of each robot in the warehouse is obtained, and an inventory receptacle parameter corresponding to each inventory receptacle matching each piece of first order information is obtained for each workstation, in a case where the obtained orders include at least one piece of first order information.

In S1006, each idle robot is determined as a target robot.

In S1008, according to a first distance and a second distance corresponding to each target robot, a plurality of traveling paths for each target robot to obtain an inventory receptacle corresponding to each piece of first order information and transport the inventory receptacle to a target workstation are determined.

In S1010, a plurality of groups of combined traveling paths are obtained by combining traveling paths for the target robots to pick up inventory receptacles corresponding to a plurality pieces of first order information.

In S1012, an inventory receptacle corresponding to each piece of first order information obtained by each target robot in a combined traveling path with a shortest total traveling distance is determined as the target inventory receptacle.

In S1014, a goods picking task corresponding to the target robot is generated according to the first order information and the target inventory receptacle, and the goods picking task is configured to instruct the target robot to transport the target inventory receptacle to a workstation corresponding to the first order information.

It should be noted that the processes of S1002 to S1014 have been described in detail in the above embodiments, and the effect achievable by the method for picking goods shown in FIG. 10 is the same as the effect achievable by the method for picking goods in the above embodiments, which will not be elaborated here to avoid repetition.

FIG. 11 is a schematic block diagram of an apparatus for picking goods in embodiments of the present disclosure. As shown in FIG. 11, the apparatus 1100 for picking goods may include a first obtaining module 1101, a second obtaining module 1102, a determining module 1103 and a task assignment module 1104.

The first obtaining module 1101 is configured to: obtain orders to be handled. The orders to be handled include a plurality pieces of order information.

The second obtaining module 1102 is configured to: obtain, in a case where the orders to be handled include at least one piece of first order information, a robot parameter corresponding to each of a plurality of robots in a warehouse system and an inventory receptacle parameter corresponding to a candidate inventory receptacle matching each piece of first order information. The first order information indicates to-be-picked goods for which an inventory receptacle is not specified.

The determining module 1103 is configured to: determine a target inventory receptacle from at least one candidate inventory receptacle and determine a target robot from the plurality of robots according to the robot parameter of each robot and/or the inventory receptacle parameter of each candidate inventory receptacle.

The task assignment module 1104 is configured to: generate a goods picking task according to the first order information and the target inventory receptacle, and send the goods picking task to the target robot to make the target robot transport the target inventory receptacle to a target workstation corresponding to the first order information according to the goods picking task.

In some embodiments, the determining module 1103 is further configured to: determine the target workstation corresponding to the first order information from a plurality of workstations in the warehouse system according to the first order information, in the case where the orders to be handled include the at least one piece of first order information.

In some embodiments, the apparatus for picking goods further includes a third obtaining module, and the third obtaining module is configured to: obtain a workload of each of the plurality of workstations. The determining module 1103 is further configured to: determine, from the plurality of workstations, a workstation with a workload less than a preset workload threshold or a workstation with a smallest workload as the target workstation.

In some embodiments, the third obtaining module is configured to: obtain a state of each of the plurality of robots; and the state of the robot includes an idle state and a non-idle state. The determining module 1103 is further configured to: determine the target workstation corresponding to the first order information from the plurality of workstations in the warehouse system in a case where a robot in the idle state exists in the plurality of robots.

In some embodiments, the determining module 1103 is configured to: determine the target inventory receptacle from the at least one candidate inventory receptacle and determine the target robot from the plurality of robots according to the robot parameter of each robot; or determine the target inventory receptacle from the at least one candidate inventory receptacle and determine the target robot from the plurality of robots according to the robot parameter of each robot and the inventory receptacle parameter of each candidate inventory receptacle.

In some embodiments, the determining module 1103 is configured to: determine a target traveling path of each robot according to the robot parameter of each robot; where the target traveling path is a partial or complete traveling path of each robot for transporting the candidate inventory receptacle; and determine the target robot and the target inventory receptacle according to the target traveling path of each robot.

In some embodiments, the robot parameter includes a state and position information of the robot. The determining module 1103 is configured to: determine a robot in an idle state from the robots as a first candidate robot according to the state of each robot; and determine a target traveling path of the first candidate robot according to position information of the first candidate robot.

In some embodiments, the robot parameter includes an idle time and position information of the robot. The determining module 1103 is configured to: determine, from the plurality of robots, a robot with an idle time greater than a preset time threshold or a robot with a longest idle time as a second candidate robot according to the idle time of each robot; and determine a target traveling path of the second candidate robot according to position information of the second candidate robot.

In some embodiments, the robot parameter includes a workload and position information of the robot. The determining module 1103 is configured to: determine, from the plurality of robots, a robot with a workload less than a preset workload threshold or a robot with a smallest workload as a third candidate robot according to the workload of each robot; and determine a target traveling path of the third candidate robot according to position information of the third candidate robot.

In some embodiments, the determining module 1103 is configured to: determine a robot with a shortest target traveling path or a robot with a target traveling path less than a preset path length threshold as the target robot according to the target traveling path of each robot; and determine the target inventory receptacle according to a distance between the target robot and each candidate inventory receptacle. A distance between the target robot and the target inventory receptacle is less than a distance between the target robot and other candidate inventory receptacles.

In some embodiments, the robot parameter includes a first distance, and the inventory receptacle parameter includes an inventory receptacle matching degree. The determining module 1103 is configured to: determine an inventory receptacle matching degree of each candidate inventory receptacle; and the inventory receptacle matching degree is configured to indicate a matching status of the first order information with each candidate inventory receptacle. The target inventory receptacle is determined from the candidate inventory receptacles according to the inventory receptacle matching degree of each candidate inventory receptacle. The third obtaining module is configured to: obtain a first distance between each robot and the target inventory receptacle. The determining module 1103 is configured to: determine, from robots in an idle state, a robot with a shortest first distance to the target inventory receptacle as the target robot according to the first distance.

In some embodiments, the determining module 1103 is configured to: determine, from the candidate inventory receptacles, a candidate inventory receptacle with a highest inventory receptacle matching degree as the target inventory receptacle.

In some embodiments, the inventory receptacle parameter further includes the number of goods stored in the inventory receptacle. The determining module 1103 is configured to: determine, in a case where the candidate inventory receptacle with the highest inventory receptacle matching degree corresponds to a plurality pieces of first order information, target order information according to the number of a first type of goods required by each piece of first order information and the number of the first type of goods stored in the candidate inventory receptacle with the highest inventory receptacle matching degree; and determine the target inventory receptacle according to the target order information.

In some embodiments, the determining module 1103 is configured to: add the number of the first type of goods required by multiple pieces of first order information to obtain a target number, in a case where the number of the first type of goods required by the plurality pieces of first order information is greater than the number of the first type of goods stored in the candidate inventory receptacle with the highest inventory receptacle matching degree; and determine each of the multiple pieces of first order information that are subjected to an addition operation as the target order information, in a case where the target number is less than or equal to the number of the first type of goods stored in the candidate inventory receptacle with the highest inventory receptacle matching degree.

In some embodiments, the determining module 1103 is configured to: determine, from the robots in the idle state, an idle robot with a shortest first distance to the target inventory receptacle as a target robot corresponding to the target order information according to the first distance.

In some embodiments, the inventory receptacle parameter further includes the number of goods stored in the inventory receptacle. The determining module 1103 is configured to: determine, in a case where the candidate inventory receptacle with the highest inventory receptacle matching degree corresponds to a plurality pieces of first order information, the number of the first type of goods required by each piece of first order information and the number of the first type of goods stored in the candidate inventory receptacle with the highest inventory receptacle matching degree; and determine the candidate inventory receptacle with the highest inventory receptacle matching degree as the target inventory receptacle, in a case where the number of the first type of goods stored in the candidate inventory receptacle with the highest inventory receptacle matching degree is greater than or equal to the number of the first type of goods required by the plurality pieces of first order information.

In some embodiments, the robot parameter includes the first distance and a second distance, and the inventory receptacle parameter includes position information of the inventory receptacle. The second distance is a distance between each candidate inventory receptacle and the target workstation. The determining module 1103 is configured to: determine each robot in the idle state as the target robot; determine a plurality of traveling paths for each target robot to transport each candidate inventory receptacle to the target workstation according to position information of each candidate inventory receptacle, and obtain a plurality of groups of combined traveling paths by combining traveling paths for the target robots to transport candidate inventory receptacles corresponding to at least one piece of first order information; and determine a candidate inventory receptacle corresponding to each target robot in a combined traveling path with a shortest total traveling distance as the target inventory receptacle, according to the first distance between each target robot and each candidate inventory receptacle and the second distance between each candidate inventory receptacle and the target workstation.

It should be noted that, for the detailed description of and the beneficial effects achievable by the apparatus 1100 for picking goods, reference may be made to the description on the method for picking goods as described above, which will not be repeated here. Each module in the above-mentioned apparatus for picking goods may be implemented in whole or in part by software, hardware or a combination thereof. Each of the above modules may be embedded in or independent of the processor in the electronic device in the form of hardware, or may be stored in the memory of the electronic device in the form of software to facilitate the invocation by the processor to execute the operations corresponding to each of the above modules.

Embodiments of the present disclosure further provide an electronic device. The electronic device may be the server in the foregoing embodiments and is configured to implement all or part of the steps of the foregoing method for picking goods.

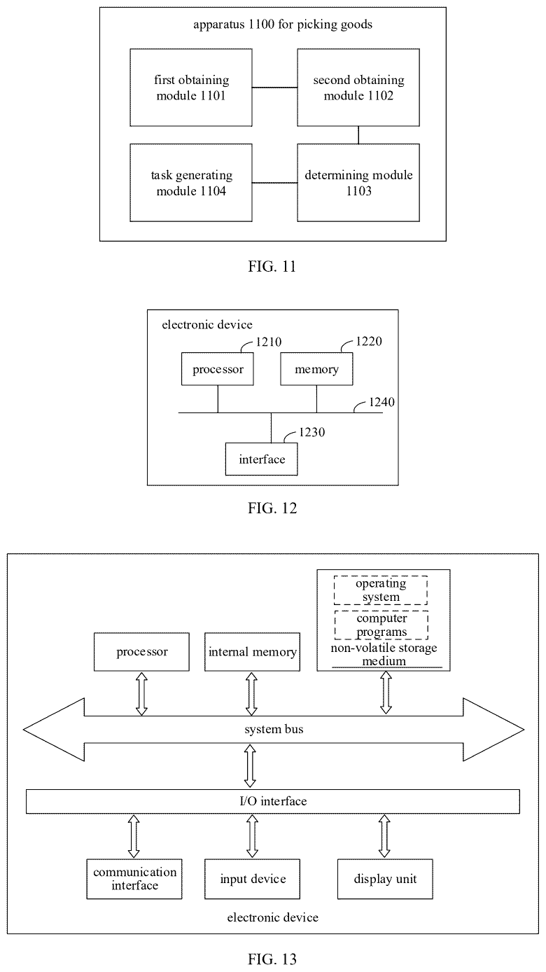

FIG. 12 is a schematic diagram of an electronic device according to embodiments of the present disclosure. As shown in FIG. 12, the electronic device includes: at least one processor 1210, a memory 1220, and at least one interface 1230. In addition, the electronic device may further include a communication bus 1240 configured to connect these components.

The at least one processor 1210 may be a CPU or a processing chip, configured to read and execute computer program instructions stored in the memory 1220, so that the at least one processor 1210 can perform the method steps in each of the foregoing embodiments.

The memory 1220 may be a non-transitory memory, which may include a volatile memory, such as a high-speed random access memory (RAM), or may include a non-volatile memory, such as at least one disk storage.

The at least one interface 1230 includes an input/output interface, and a communication interface. The communication interface may be a wired or wireless interface, thereby realizing communication connections between the electronic device and other devices. The input/output interface may be used to connect peripheral devices, such as displays, keyboards, etc.

In some embodiments, the memory 1220 stores computer-readable program instructions. When the processor 1210 reads and executes the program instructions in the memory 1220, the method for picking goods in the foregoing embodiments can be implemented.

In addition, the embodiments of the present disclosure further provide a computer program product for storing computer-readable program instructions. When the instructions are executed by the processor 1210, the method for picking goods in the foregoing embodiments can be implemented.

FIG. 13 is a schematic diagram of another electronic device according to embodiments of the present disclosure. For example, the electronic device may be a terminal, and the terminal may be a robot or a vehicle, or the like. The diagram of the internal structure of the terminal is shown in FIG. 13.

In some examples, the electronic device includes a processor, a memory, a communication interface, a display and an input device connected through a system bus. The processor of the electronic device is used to provide computing and control capabilities. The memory of the electronic device includes a non-volatile storage medium and an internal memory. The non-volatile storage medium stores an operating system and computer programs. The internal memory provides an environment for execution of the operating system and computer programs in the non-volatile storage medium. The communication interface of the electronic device is used for wired or wireless communication with external terminals. The wireless mode may be implemented through WIFI, an operator network, NFC (Near Field Communication) or other technologies. The computer programs, when executed by a processor, cause the method for picking goods to be implemented. The display of the electronic device may be a liquid crystal display or an electronic ink display. The input device of the electronic device may be a touch layer covered on the display, or may be a button, trackball or a touchpad provided on a housing of the electronic device, or may also be an external keyboard, touchpad or mouse, etc.

Those skilled in the art can understand that the structures shown in FIG. 12 and FIG. 13 are block diagrams of partial structures related to the solutions of the present disclosure, and do not constitute a limitation on the electronic device to which the solution of the present disclosure is applied. The electronic device may include more or fewer components than those shown in the figures, or some combinations of components, or have different arrangements of components.

In some embodiments, the embodiments of the present disclosure further provide an electronic device, including a memory and a processor. Computer programs are stored in the memory. When the processor executes the computer programs, the processor implements the steps of the method in any of the above embodiments.

In some embodiments, the embodiments of the present disclosure provide a computer-readable storage medium on which computer programs are stored. When the computer programs are executed by a processor, the steps of the method in any of the above embodiments are implemented.

In some embodiments, the embodiments of the present disclosure provide a computer program product including computer programs that, when executed by a processor, cause the steps of the method in any of the above embodiments to be implemented.

It should be noted that user information (including but not limited to user equipment information, user personal information, etc.) and data (including but not limited to data used for analysis, stored data, displayed data, etc.) involved in the present disclosure are information and data authorized by users or fully authorized by related parties. Those of ordinary skill in the art can understand that all or part of the processes in the methods of the above embodiments may be completed by relevant hardware instructed by the computer programs. The computer programs may be stored in a non-volatile computer-readable storage medium. When the computer programs are executed, the processes of the above method embodiments may be implemented. Any reference to the memory, database or other media used in the embodiments provided in the present disclosure may include at least one of the non-volatile memory or the volatile memory. The non-volatile memory may include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM)), phase change memory (PCM), graphene memory, etc. The volatile memory may include random access memory (RAM) or external cache memory. By way of illustration but not limitation, the RAM may be in various forms, such as static random access memory (SRAM) or dynamic random access memory (DRAM). The databases involved in the various embodiments provided in present disclosure may include at least one of a relational database or a non-relational database. The non-relational database may include, but is not limited to, a block chain-based distributed database, etc. The processor involved in the various embodiments provided in present disclosure may include, but is not limited to, a general-purpose processor, a central processing unit, a graphics processor, a digital signal processor, a programmable logic device, a quantum computing-based data processing logic device, etc.

The technical features of the above embodiments may be combined arbitrarily. To make the description concise, not all possible combinations of the technical features in the above embodiments are described. However, as long as there is no contradiction in the combination of these technical features, it should be considered to be within the scope of the present specification.

The above embodiments merely describe some implementations of the present disclosure, and the descriptions thereof are relatively specific and detailed, which however should not be construed as limiting the patent scope of the present disclosure. It should be pointed out that, for those having ordinary skills in the art, variations and improvements can be made without departing from the concept of the present disclosure, and these all fall within the protection scope of the present disclosure. Therefore, the protection scope of the present disclosure should be determined by the appended claims.

1. A method for picking goods, comprising:
obtaining orders to be handled; wherein the orders to be handled comprise a plurality pieces of order information;
obtaining, in a case where the orders to be handled comprise at least one piece of first order information, a robot parameter corresponding to each of a plurality of robots in a warehouse system and an inventory receptacle parameter corresponding to a candidate inventory receptacle matching each piece of first order information, wherein the first order information indicates to-be-picked goods for which an inventory receptacle is not specified;
determining a target inventory receptacle from at least one candidate inventory receptacle and determining a target robot from the plurality of robots according to the robot parameter of each robot, or the inventory receptacle parameter of each candidate inventory receptacle, or both the robot parameter of each robot and the inventory receptacle parameter of each candidate inventory receptacle; and
generating a goods picking task according to the first order information and the target inventory receptacle, and sending the goods picking task to the target robot to make the target robot transport the target inventory receptacle to a target workstation corresponding to the first order information according to the goods picking task.

2. The method according to claim 1, after obtaining the orders to be handled, further comprising:
determining the target workstation corresponding to the first order information from a plurality of workstations in the warehouse system according to the first order information, in the case where the orders to be handled comprise the at least one piece of first order information.

3. The method according to claim 2, wherein determining the target workstation corresponding to the first order information from the plurality of workstations in the warehouse system according to the first order information comprises:
obtaining a workload of each of the plurality of workstations; and
determining, from the plurality of workstations, a workstation with a workload less than a preset workload threshold or a workstation with a smallest workload as the target workstation.

4. The method according to claim 1, further comprising:
obtaining a state of each of the plurality of robots; wherein the state of each robot comprises an idle state and a non-idle state; and
determining the target workstation corresponding to the first order information from a plurality of workstations in the warehouse system in a case where a robot in the idle state exists in the plurality of robots.

5. The method according to claim 1, wherein determining the target inventory receptacle from the at least one candidate inventory receptacle and determining the target robot from the plurality of robots according to the robot parameter of each robot, or the inventory receptacle parameter of each candidate inventory receptacle, or both the robot parameter of each robot and the inventory receptacle parameter of each candidate inventory receptacle comprise:
determining the target inventory receptacle from the at least one candidate inventory receptacle and determining the target robot from the plurality of robots according to the robot parameter of each robot; or
determining the target inventory receptacle from the at least one candidate inventory receptacle and determining the target robot from the plurality of robots according to the robot parameter of each robot and the inventory receptacle parameter of each candidate inventory receptacle.

6. The method according to claim 5, wherein determining the target inventory receptacle from the at least one candidate inventory receptacle and determining the target robot from the plurality of robots according to the robot parameter of each robot comprise:
determining a target traveling path of each robot according to the robot parameter of each robot; wherein the target traveling path is a partial or complete traveling path of each robot for transporting the candidate inventory receptacle; and
determining the target robot and the target inventory receptacle according to the target traveling path of each robot.

7. The method according to claim 6, wherein the robot parameter comprises a state and position information of each robot; and determining the target traveling path of each robot according to the robot parameter of each robot comprises:
determining a robot in an idle state from the plurality of robots as a first candidate robot according to the state of each robot; and
determining a target traveling path of the first candidate robot according to position information of the first candidate robot.

8. The method according to claim 6, wherein the robot parameter comprises an idle time and position information of each robot, and determining the target traveling path of each robot according to the robot parameter of each robot comprises:
determining, from the plurality of robots, a robot with an idle time greater than a preset time threshold or a robot with a longest idle time as a second candidate robot according to the idle time of each robot; and
determining a target traveling path of the second candidate robot according to position information of the second candidate robot.

9. The method according to claim 6, wherein the robot parameter comprises a workload and position information of each robot, and determining the target traveling path of each robot according to the robot parameter of each robot comprises:
determining, from the plurality of robots, a robot with a workload less than a preset workload threshold or a robot with a smallest workload as a third candidate robot according to the workload of each robot; and
determining a target traveling path of the third candidate robot according to position information of the third candidate robot.

10. The method according to claim 6, wherein determining the target robot and the target inventory receptacle according to the target traveling path of each robot comprises:
determining a robot with a shortest target traveling path or a robot with a target traveling path less than a preset path length threshold as the target robot according to the target traveling path of each robot; and
determining the target inventory receptacle according to a distance between the target robot and each candidate inventory receptacle; wherein a distance between the target robot and the target inventory receptacle is less than a distance between the target robot and other candidate inventory receptacles.

11. The method according to claim 5, wherein the robot parameter comprises a first distance, and the inventory receptacle parameter comprises an inventory receptacle matching degree; and determining the target inventory receptacle from the at least one candidate inventory receptacle and determining the target robot from the plurality of robots according to the robot parameter of each robot and the inventory receptacle parameter of each candidate inventory receptacle comprise:
determining the inventory receptacle matching degree of each candidate inventory receptacle; wherein the inventory receptacle matching degree is configured to indicate a matching status of the first order information with each candidate inventory receptacle;
determining the target inventory receptacle from a plurality of candidate inventory receptacles according to the inventory receptacle matching degree of each candidate inventory receptacle;
obtaining a first distance between each robot and the target inventory receptacle; and
determining, from robots in an idle state, a robot with a shortest first distance to the target inventory receptacle as the target robot according to the first distance.

12. The method according to claim 11, wherein determining the target inventory receptacle from the plurality of candidate inventory receptacles according to the inventory receptacle matching degree of each candidate inventory receptacle comprises:
determining, from the plurality of candidate inventory receptacles, a candidate inventory receptacle with a highest inventory receptacle matching degree as the target inventory receptacle.

13. The method according to claim 12, wherein the inventory receptacle parameter further comprises a number of goods stored in the inventory receptacle; and determining the candidate inventory receptacle with the highest inventory receptacle matching degree as the target inventory receptacle comprises:
determining, in a case where the candidate inventory receptacle with the highest inventory receptacle matching degree corresponds to a plurality pieces of first order information, target order information according to a number of a first type of goods required by each piece of first order information and a number of the first type of goods stored in the candidate inventory receptacle with the highest inventory receptacle matching degree; and
determining the target inventory receptacle according to the target order information.

14. The method according to claim 13, wherein determining the target order information according to the number of the first type of goods required by each piece of first order information and the number of the first type of goods stored in the candidate inventory receptacle with the highest inventory receptacle matching degree comprises:
adding the number of the first type of goods required by multiple pieces of first order information to obtain a target number, in a case where the number of the first type of goods required by the plurality pieces of first order information is greater than the number of the first type of goods stored in the candidate inventory receptacle with the highest inventory receptacle matching degree; and
determining each of the multiple pieces of first order information that are subjected to an addition operation as the target order information, in a case where the target number is less than or equal to the number of the first type of goods stored in the candidate inventory receptacle with the highest inventory receptacle matching degree.

15. The method according to claim 14, wherein determining, from the robots in the idle state, the robot with the shortest first distance to the target inventory receptacle as the target robot according to the first distance comprises:
determining, from the robots in the idle state, an idle robot with the shortest first distance to the target inventory receptacle as a target robot corresponding to the target order information according to the first distance.

16. The method according to claim 12, wherein the inventory receptacle parameter further comprises a number of goods stored in the inventory receptacle; and determining the candidate inventory receptacle with the highest inventory receptacle matching degree as the target inventory receptacle comprises:
determining, in a case where the candidate inventory receptacle with the highest inventory receptacle matching degree corresponds to a plurality pieces of first order information, a number of a first type of goods required by each piece of first order information and the number of the first type of goods stored in the candidate inventory receptacle with the highest inventory receptacle matching degree; and
determining the candidate inventory receptacle with the highest inventory receptacle matching degree as the target inventory receptacle, in a case where the number of the first type of goods stored in the candidate inventory receptacle with the highest inventory receptacle matching degree is greater than or equal to the number of the first type of goods required by the plurality pieces of first order information.

17. The method according to claim 11, wherein the robot parameter comprises the first distance and a second distance, and the inventory receptacle parameter comprises position information of the inventory receptacle; wherein the second distance is a distance between each candidate inventory receptacle and the target workstation;
determining the target inventory receptacle from the at least one candidate inventory receptacle and determining the target robot from the plurality of robots according to the robot parameter of each robot and the inventory receptacle parameter of each candidate inventory receptacle comprise:
determining each robot in the idle state as the target robot;
determining a plurality of traveling paths for each target robot to transport each candidate inventory receptacle to the target workstation according to position information of each candidate inventory receptacle, and obtaining a plurality of groups of combined traveling paths by combining traveling paths for target robots to transport candidate inventory receptacles corresponding to at least one piece of first order information; and
determining a candidate inventory receptacle corresponding to each target robot in a combined traveling path with a shortest total traveling distance as the target inventory receptacle, according to the first distance between each target robot and each candidate inventory receptacle and the second distance between each candidate inventory receptacle and the target workstation.

18. (canceled)

19. An electronic device, comprising a memory and a processor, wherein the memory stores a computer program, and the processor is configured to:
obtain orders to be handled; wherein the orders to be handled comprise a plurality pieces of order information;
obtain, in a case where the orders to be handled comprise at least one piece of first order information, a robot parameter corresponding to each of a plurality of robots in a warehouse system and an inventory receptacle parameter corresponding to a candidate inventory receptacle matching each piece of first order information, wherein the first order information indicates to-be-picked goods for which an inventory receptacle is not specified;
determine a target inventory receptacle from at least one candidate inventory receptacle and determine a target robot from the plurality of robots according to at least at one of: the robot parameter of each robot or the inventory receptacle parameter of each candidate inventory receptacle; and
generate a goods picking task according to the first order information and the target inventory receptacle, and send the goods picking task to the target robot to make the target robot transport the target inventory receptacle to a target workstation corresponding to the first order information according to the goods picking task.

20. A non-transitory computer-readable storage medium having a computer program stored thereon, wherein the computer program, when executed by a processor, causes the processor to:
obtain orders to be handled; wherein the orders to be handled comprise a plurality pieces of order information;
obtain, in a case where the orders to be handled comprise at least one piece of first order information, a robot parameter corresponding to each of a plurality of robots in a warehouse system and an inventory receptacle parameter corresponding to a candidate inventory receptacle matching each piece of first order information, wherein the first order information indicates to-be-picked goods for which an inventory receptacle is not specified;
determine a target inventory receptacle from at least one candidate inventory receptacle and determine a target robot from the plurality of robots according to at least at one of: the robot parameter of each robot or the inventory receptacle parameter of each candidate inventory receptacle; and
generate a goods picking task according to the first order information and the target inventory receptacle, and send the goods picking task to the target robot to make the target robot transport the target inventory receptacle to a target workstation corresponding to the first order information according to the goods picking task.

21. The method according to claim 7, wherein determining the target robot and the target inventory receptacle according to the target traveling path of each robot comprises:
determining a robot with a shortest target traveling path or a robot with a target traveling path less than a preset path length threshold as the target robot according to the target traveling path of each robot; and
determining the target inventory receptacle according to a distance between the target robot and each candidate inventory receptacle; wherein a distance between the target robot and the target inventory receptacle is less than a distance between the target robot and other candidate inventory receptacles.
